(19) United States
(12) Patent Application Publication
(10) Pub. No.: US 2010/0194701 A1
(43) Pub. Date: Aug. 5, 2010

(54) METHOD OF RECOGNIZING A MULTI-TOUCH AREA ROTATION GESTURE

(76) Inventor: Jared C. Hill, Fruit Heights, UT (US)

Correspondence Address: MORRISS OBRYANT COMPAGNI, P.C., 734 EAST 200 SOUTH, SALT LAKE CITY, UT, 84102, US

(21) Appl. No.: 12/607,764

(22) Filed: Oct. 28, 2009

Related U.S. Application Data
(60) Provisional application No. 61/109,109, filed on Oct. 28, 2008.

(51) Int. Cl. G06F 3/041

(52) U.S. Cl. 345/173; 178/18.03

(57) ABSTRACT

A system and method for detecting and tracking multiple objects on a touchpad or touchscreen, wherein the method provides a new data collection algorithm, wherein the method reduces a calculation burden on a processor performing detection and tracking algorithms, wherein multiple objects are treated as elements of a single object and not as separate objects, wherein the location of the objects are treated as corners of a quadrilateral outline of a single object when two objects are detected, and wherein the multiple objects are capable of being tracked so as to perform a multi-touch rotation gesture.

### CROSS REFERENCE TO RELATED APPLICATIONS

This document claims priority to and incorporates by reference all of the subject matter included in the provisional patent application docket number 4438.CIRQ.PR, having Ser. No. 61/109,109 and filed on Oct. 28, 2008.

### BACKGROUND OF THE INVENTION

1. Field of the Invention

This invention relates generally to methods of providing input to a touchpad. Specifically, the invention relates to a method of detecting and tracking a rotational gesture when that gesture is made using multiple objects on a touch sensitive surface by treating the multiple objects as a single object whose perimeter or end-points are defined by the multiple objects, thereby treating the multiple objects as a single object in order to simplify detection and tracking algorithms.

2. Description of Related Art

As portable electronic appliances become more ubiquitous, the need to efficiently control them is becoming increasingly important. The wide array of portable electronic devices that can benefit from using a touch sensitive surface as a means of providing user input include, but should not be considered limited to, music players, DVD players, video file players, personal digital assistants (PDAs), digital cameras and camcorders, mobile telephones, smart phones, laptop and notebook computers, global positioning satellite (GPS) devices and other portable electronic devices. Even stationary electronic appliances such as desktop computers can take advantage of an improved system and method of providing input to a touchpad that provides greater functionality to the user.

One of the main problems that many portable and stationary electronic appliances have is that their physical dimensions limit the number of ways in which communicating with the appliances is possible. There is typically a very limited amount of space that is available for an interface when portability is an important feature. For example, mobile telephones often referred to as smart phones are now providing the functions of a telephone and a personal digital assistant (PDA). Typically, PDAs require a significant amount of surface area for input and a display screen to be practical.

Mobile smart phones provide an LCD having touch sensitive screen capabilities. With a finite amount of space available for a display screen space because the smart phone is portable, a means was created for expanding and shrinking the relative size of the data being displayed. The multi-touch gesture is often referred to as a “pinch and zoom” action.

There are other multi-touch gestures that also have great utility when using a multi-touch capable device. One multi-touch gesture in particular is a rotation command.

Disadvantageously, one method that is well known in the prior for performing the detection and tracking of the thumb and forefinger on a touchpad surface is to detect and track the thumb and forefinger (or whichever digits are being used to pinch and reverse pinch) as separate objects on the touch sensitive surface. Tracking multiple objects means that the calculations that are performed for one object must be performed for each object. Thus, the calculation burden on any touchpad processor increases substantially for each finger or pointing object (hereinafter used interchangeably) that is being tracked.

It would be an improvement over the prior art to simplify the process of detecting and tracking multiple objects on a touch sensitive surface such as a touchpad or a touchscreen (referred to hereinafter as a “touchpad”).

It is useful to describe one embodiment of touchpad and touchscreen technology that can be used in the present invention. Specifically, the capacitance-sensitive touchpad and touchscreen technology of CIRQUE® Corporation can be used to implement the present invention. The CIRQUE® Corporation touchpad is a mutual capacitance-sensing device and an example is illustrated in FIG. 1. The touchpad can be implemented using an opaque surface or using a transparent surface. Thus, the touchpad can be operated as a conventional touchpad or as a touch sensitive surface on a display screen, and thus as a touch screen.

In this touchpad technology of Cirque® Corporation, a grid of row and column electrodes is used to define the touch-sensitive area of the touchpad. Typically, the touchpad is a rectangular grid of approximately 16 by 12 electrodes, or 8 by 6 electrodes when there are space constraints. Interlaced with these row and column electrodes is a single sense electrode. All position measurements are made through the sense electrode. However, the row and column electrodes can also act as the sense electrode, so the important aspect is that at least one electrode is driving a signal, and another electrode is used for detection of a signal.

In more detail, FIG. 1 shows a capacitance sensitive touchpad 10 as taught by CIRQUE® Corporation includes a grid of row (12) and column (14) (or X and Y) electrodes in a touchpad electrode grid. All measurements of touchpad parameters are taken from a single sense electrode 16 also disposed on the touchpad electrode grid, and not from the X or Y electrodes 12, 14. No fixed reference point is used for measurements. Touchpad sensor control circuitry 20 generates signals from P, N generators 22, 24 (positive and negative) that are sent directly to the X and Y electrodes 12, 14 in various patterns. Accordingly, there is typically a one-to-one correspondence between the number of electrodes on the touchpad electrode grid, and the number of drive pins on the touchpad sensor control circuitry 20. However, this arrangement can be modified using multiplexing of electrodes.

The touchpad 10 does not depend upon an absolute capacitive measurement to determine the location of a finger (or other capacitive object) on the touchpad surface. The touchpad 10 measures an imbalance in electrical charge to the sense line 16. When no pointing object is on the touchpad 10, the touchpad sensor control circuitry 20 is in a balanced state, and there is no signal on the sense line 16. There may or may not be a capacitive charge on the electrodes 12, 14. In the methodology of CIRQUE® Corporation, that is irrelevant. When a pointing device creates imbalance because of capacitive coupling, a change in capacitance occurs on the plurality of electrodes 12, 14 that comprise the touchpad electrode grid. What is measured is the change in capacitance, and not the absolute capacitance value on the electrodes 12, 14. The touchpad 10 determines the change in capacitance by measuring the amount of charge that must be injected onto the sense line 16 to reestablish or regain balance on the sense line.

The touchpad 10 must make two complete measurement cycles for the X electrodes 12 and for the Y electrodes 14 (four complete measurements) in order to determine the position of a pointing object such as a finger. The steps are as follows for both the X 12 and the Y 14 electrodes:

First, a group of electrodes (say a select group of the X electrodes 12) are driven with a first signal from P, N generator 22 and a first measurement using mutual capacitance measurement device 26 is taken to determine the location of the largest signal. However, it is not possible from this one measurement to know whether the finger is on one side or the other of the closest electrode to the largest signal.

Next, shifting by one electrode to one side of the closest electrode, the group of electrodes is again driven with a signal. In other words, the electrode immediately to the one side of the group is added, while the electrode on the opposite side of the original group is no longer driven.

Third, the new group of electrodes is driven and a second measurement is taken.

Finally, using an equation that compares the magnitude of the two signals measured, the location of the finger is determined.

Accordingly, the touchpad 10 measures a change in capacitance in order to determine the location of a finger. All of this hardware and the methodology described above assume that the touchpad sensor control circuitry 20 is directly driving the electrodes 12, 14 of the touchpad 10. Thus, for a typical 12×16 electrode grid touchpad, there are a total of 28 pins (12+16=28) available from the touchpad sensor control circuitry 20 that are used to drive the electrodes 12, 14 of the electrode grid.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes on the same rows and columns, and other factors that are not material to the present invention.

Although the CIRQUE® touchpad described above uses a grid of X and Y electrodes and a separate and single sense electrode, the sense electrode can also be the X or Y electrodes by using multiplexing. Either design will enable the present invention to function.

The underlying technology for the CIRQUE® Corporation touchpad is based on capacitive sensors. However, other touchpad technologies can also be used for the present invention. These other proximity-sensitive and touch-sensitive touchpad technologies include electromagnetic, inductive, pressure sensing, electrostatic, ultrasonic, optical, resistive membrane, semi-conductive membrane or other finger or stylus-responsive technology.

The prior art includes a description of a touchpad that is already capable of the detection and tracking of multiple objects on a touchpad. This prior art patent teaches and claims that the touchpad detects and tracks individual objects anywhere on the touchpad. The patent describes a system whereby objects appear as a “maxima” on a signal graphed as a curve that indicates the presence and location of pointing objects. Consequently, there is also a “minima” which is a low segment on the signal graph which indicates that no pointing object is being detected.

FIG. 2 is a graph illustrating the concept of a first maxima 30, a minima 32 and a second maxima 34 that is the result of the detection of two objects with a gap between them on a touchpad. The prior art is always tracking the objects as separate and individual objects, and consequently must follow each object as it moves around the touchpad.

It would be an advantage over the prior art to provide a new detection and tracking method that does not require the system to determine how many objects are on the touchpad surface, and yet still be capable of being aware of their presence. It would be another advantage to use this new method to perform a multi-touch rotation gesture.

### BRIEF SUMMARY OF THE INVENTION

In a preferred embodiment, the present invention is system and method for detecting and tracking multiple objects on a touchpad or touchscreen, wherein the method provides a new data collection algorithm, wherein the method reduces a calculation burden on a processor performing detection and tracking algorithms, wherein multiple objects are treated as elements of a single object and not as separate objects, wherein the location of the objects are treated as corners of a quadrilateral outline of a single object when two objects are detected, and wherein the multiple objects are capable of being tracked so as to perform a multi-touch rotation gesture.

In a first aspect of the invention, existing touchpad and touchscreen (hereinafter referred to collectively as “touchpad”) hardware and scanning routines can be used with this new analysis algorithm.

In a second aspect of the invention, the new analysis algorithm can be implemented in firmware without hardware changes.

In a third aspect, a touchpad performs a normal scanning procedure to obtain data from all the electrodes on the touchpad, wherein the data is analyzed by looking for an object by starting at an outer edge or boundary of a touchpad and then moving inwards or across the touchpad surface. Data analysis ends when the edge of an object is detected in the data. Analysis then begins on the outer edge or boundary opposite the first outer edge, and then continuing inwards. Again, data analysis ends when the edge of an object is detected in the data. The process is then repeated in the orthogonal dimension. Thus if the first boundaries are both horizontal boundaries of the touchpad, then analysis begins using both of the vertical boundaries. Analysis never shows what is detected on the touchpad past the edge of the first object from each direction. Thus, the touchpad never determines the total number of objects on the touchpad, and never has to calculate anything but the edge of objects from four directions, thereby substantially decreasing the calculation overhead on a touchpad processor.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of the components of a capacitance-sensitive touchpad as made by CIRQUE® Corporation and which can be operated in accordance with the principles of the present invention.

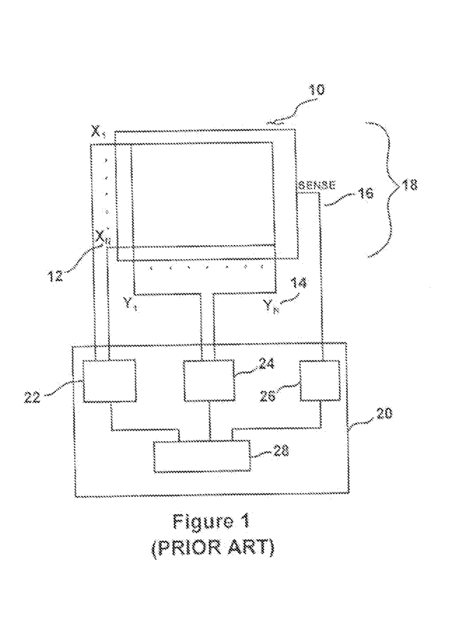

FIG. 2 is a graph showing the detection of two objects on a touchpad as taught by the prior art.

FIG. 3 is a top view of a touchpad of the present invention showing a user's hand with a thumb and forefinger touching the surface thereof.

FIG. 4 is a top view of the touchpad showing that the touchpad sees a single object when the thumb and forefinger are touching.

FIG. 5 is a top view of the touchpad showing that the touchpad sees two objects when the thumb and forefinger are separated, but are treated as a single object.

FIG. 6 is a top view of the touchpad showing that the touchpad sees multiple objects when three or more fingers make contact with the touchpad, but are still treated as a single object.

FIG. 7 is a top view of a touchpad showing that multiple objects may be tracked as a single large object.

FIG. 8 is a top view of a touchpad of the present invention showing the position of two objects in the corner of an outline of the larger object.

FIG. 9 is a top view of a touchpad showing how the movement of an arc finger is interpreted as clockwise or counterclockwise movement.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

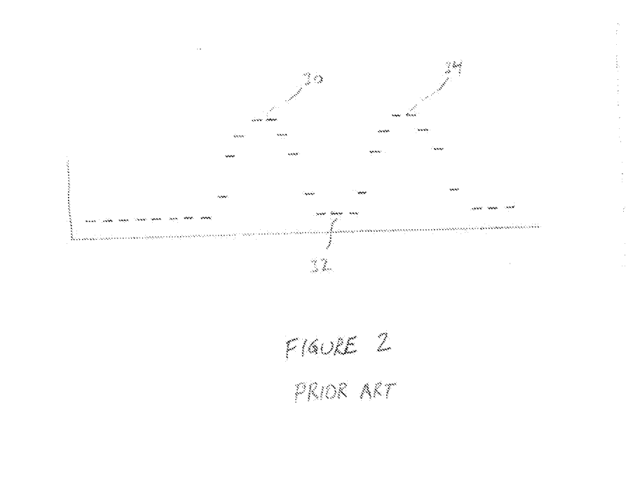

Before describing the embodiments of the present invention, it is important to understand that the touchpad hardware of the present invention scans all of the touchpad electrodes. The CIRQUE® touchpad has always had the ability to collect the same raw data as shown in FIG. 2 of the prior art. Furthermore, the manner in which the electrodes of the touchpad are scanned are not an element of this patent. The CIRQUE® Corporation touchpad used in the present invention appears to be unique in that electrodes are scanned sequentially in groups and not simultaneously. Nevertheless, what is relevant to the invention is not how the data is gathered from the electrodes of the touchpad, but rather how that data is used and analyzed. The importance of the new data collection algorithm will become apparent through the disclosure below.

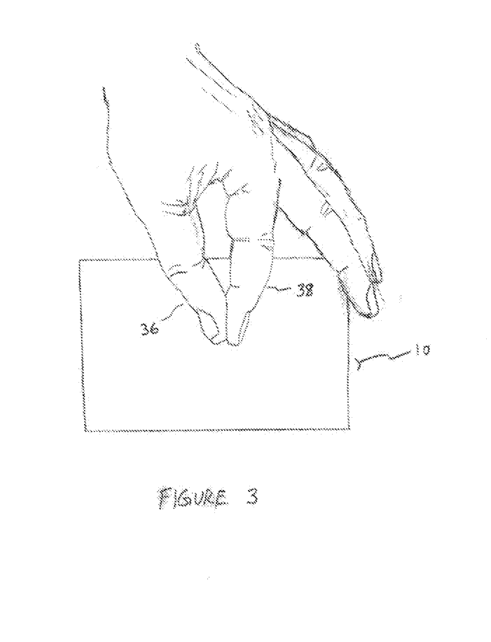

FIG. 3 is provided as a top elevational view of a touchpad 10 that is made in accordance with the principles of the present invention. The touchpad 10 is capable of detecting and tracking multiple objects simultaneously. Consider a thumb 36 and forefinger 38 which are pressed together and placed at any location on the touchpad 10. It is likely that the thumb 36 and forefinger 38 combination will be seen as a single object by the touchpad 10. This is likely to occur because the tissue of the thumb 36 and forefinger 38 will likely be pressed hard enough to deform and essentially leave no gap between them when pressed against the touchpad 10. The normal detection algorithms will operate in the manner that they presently operate when a single object is detected. That is to say that a center point or centroid is determined for the object detected. This centroid is considered to be the position on the touchpad 10 of the object detected.

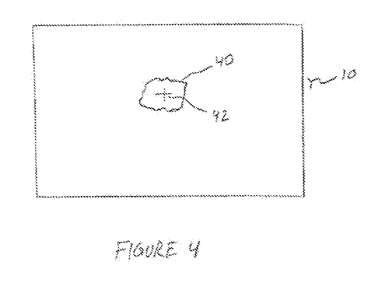

FIG. 4 is a top elevational view of what the touchpad 10 might detect at the location of the thumb 36 and forefinger 38 on the touchpad 10. For example, the touchpad 10 might detect an irregular but roughly circular outline 40, with the location of a center point 42 indicated by the crosshairs. The object 40 is an approximation only, and should not be considered as a precise representation of what is detected by the touchpad 10. What is important to understand is that generally, only a single object will be detected.

As the thumb 36 and forefinger 38 are moved apart in the reverse pinching motion, the touchpad 10 could detect two separate objects. While touchpads have been capable of detecting multiple objects since their initial development, the detection and tracking of more than one object on a touchpad surface has always been assumed to be undesirable, and so algorithms were implemented so that one of the detected objects would be ignored while the location of the desired object would continue to be tracked. The decision as to which object to track could obviously be modified. However, it has been customary in the prior art to track the largest object while ignoring the smaller object. Nevertheless, this is an arbitrary decision, and some other means of selecting which object to track can be used, such as only tracking the first object to be detected.

The present invention is a new method of how to use this unique method of the detection and tracking of multiple objects to perform a multi-touch gesture. There are essentially two different detection scenarios. The first scenario occurs when only two objects are detected. The second scenario occurs when more than two objects are detected.

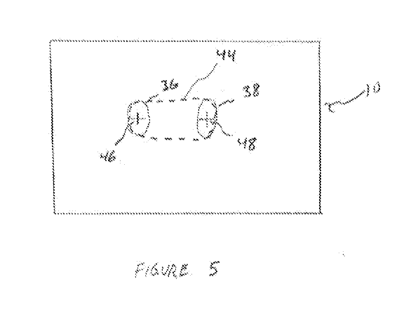

An illustration of the first scenario is shown in FIG. 5. FIG. 5 is an illustration of what a touchpad 10 might detect when the thumb 36 and the forefinger 38 are laying sideways against the touchpad 10 when the thumb and forefinger are separated. FIG. 5 indicates that two objects 36, 38 are detected, each having its own centroid 46, 48 respectively and shown as crosshairs. Dotted line 44 is provided to illustrate how the method of the present invention uses the data from the two objects 36, 38. The dotted line 44 is used to indicate that the method of the present invention will treat the two objects 36, 38 as a single large object. This single object is elongated and thus appears to have two endpoints 46, 48.

If the thumb 36 and forefinger 38 are moved apart as shown in FIG. 5, then the method of the present invention treats the object as being a larger single object on the touchpad 10. Similarly, moving the thumb 36 and forefinger 38 closer together will result in the method seeing a smaller object on the touchpad 10, regardless of whether the thumb and forefinger are touching or not. It is emphasized that the algorithms that are needed to track a single object, be it large or small, are simpler than if the method has to track only a single object while intentionally ignoring a second object.

To state the first embodiment in a succinct manner, while the present invention recognizes that two objects are physically present on the touchpad 10, the data collection algorithms of the first embodiment will treat the two objects as if they are a single object.

It should be recognized that this scenario of detecting a single large object also occurs when the palm of a hand is placed on the touchpad 10. In fact, algorithms are typically developed to handle the situation when a large single object is detected. One typical scenario is to ignore the large object, assuming that a user has unintentionally rested the palm of a hand on the touchpad, and that no contact was intended.

Consider the heel of the palm of a hand being placed on the touchpad 10. The heel is relatively small and is a single object. Now if the palm is rocked forward so that more of the palm makes contact with the touchpad 10, the larger palm is still a single object, and it is seen by the touchpad 10 as a single object. Thus, the new data collection algorithm of the present invention functions the same when a single large object is detected and when two objects are detected. The first embodiment is programmed to look at the points of contact and to treat them as the outer edges of a single large object, whether they are formed from a single object such as the palm of a hand or formed by two or more objects such as the thumb 36 and forefinger 38. It should be apparent that the thumb 36 and forefinger 38 can be any two digits of a user's hand or even fingers from two different hands.

The present invention operates essentially in the same manner when there are more than two objects detected on the touchpad 10. Instead of seeing endpoints, the present invention will see objects that indicate the perimeter or boundary of a single large object. Thus, the centroid of the single large object can be the “center” of the perimeter as determined by the algorithm.

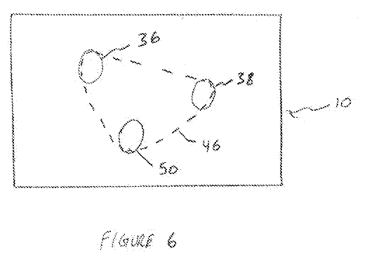

In FIG. 6, the scenario is now illustrated where more than two objects are making contact with the touchpad 10. In this embodiment, the touchpad 10 is programmed to use the centroids of the multiple points of contact. The centroids are the outer edges of a single large object, whether they are formed from a single object such as the palm of a hand or formed from multiple objects such as the thumb 36, the forefinger 38 and at least one other finger. It should be apparent that the thumb 36 and forefinger 38 can also be replaced by any other digits of a user's hand or even digits of different hands.

Thus in FIG. 6 three objects 36, 38 and 50 are now detected. Dotted line 46 is used to show that the size of the object is determined by using the detected objects as the perimeter of the single object.

Having determined that the touchpad 10 can now treat multiple objects as a single object, this information can now be used by the present invention to perform the operation described previously for performing a multi-touch area rotation gesture.

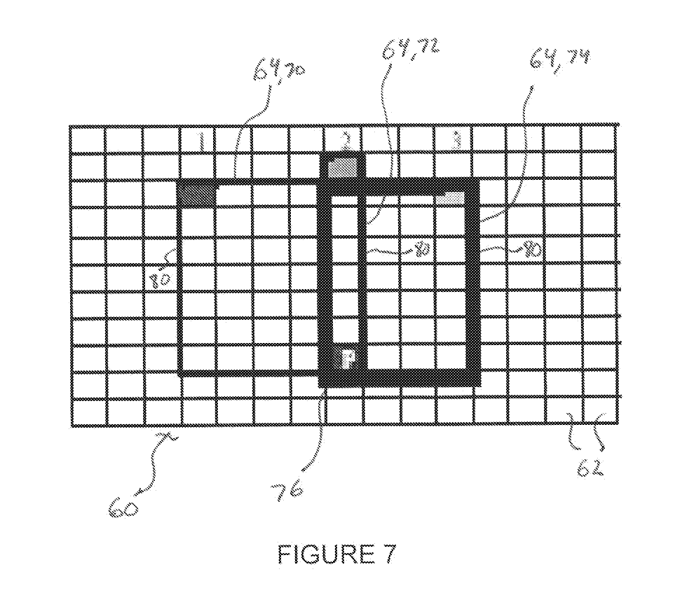

FIG. 7 is a schematic diagram of a touchpad 60 that is divided into cells or grid boxes 62 and outlines 64. The cells 62 and outlines 64 are imaginary, but are being used to illustrate the concepts of a multi-touch area gesture. The process or algorithm of the multi-touch area gesture is as follows.

When two objects are disposed on a touchpad 50, the present invention will essentially create quadrilateral outlines 64 of the objects. The outline 64 will therefore have four corners. The method of detection of the present invention does not identify in which corners the actual objects are present that define the outline.

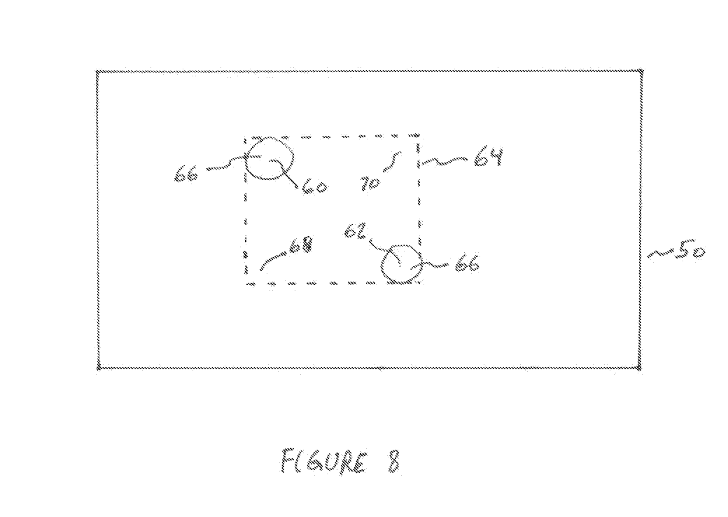

FIG. 8 illustrates the concept of two objects defining two corners 66 of an outline 64. If contact is made by two objects at points 60 and 62, the method does not determine if the objects are actually at points 60 and 62, or 68 and 70. However, the first step of the algorithm of the present invention is to determine which of the four corners is planted (defined as “remains stationary”) by a planted finger over a set of unique outlines 64, wherein the outline 64 is the object that will be used to track the area of the gesture on the touchpad 60. FIG. 7 shows three outlines 70, 72, 74 differentiated by unique borders. The grid box P 76 is the grid box that remains the same, thus marking a planted finger or planted corner. The grid boxes 62 marked “1”, “2”, and “3” are the successive positions of a moving or arc finger or other object on the touchpad 60. The planted corner 76 is determined by finding out which grid box 62 of the outlines 70, 72, 74 remain constant during the multi-touch area rotation gesture.

It is assumed that if one of the objects is identified as the planted finger, then by default the other finger is the moving object. The moving finger is also referred to as the arc finger, assuming that the moving object is a finger.

After identification of the planted corner 76, the second step of the algorithm is to ensure that the change in area of the outlines 64 meets some predetermined minimum movements. One of four conditions in the change in the size of the area of an outline 64 must be met in order to consider the gesture a possible multi-touch area rotation gesture.

The first possible condition is that the change in the width of the outline 64 is greater than a predetermined constant, and the change in the height of the outline is less than or equal to zero.

The second possible condition is that the change in the width of the outline 64 is less than a predetermined negative constant, and the change in the height of the outline is greater than or equal to zero.

The third possible condition is that the change in the height of the outline 64 is greater than a constant, and the change in the width of the outline is greater than or equal to zero.

The fourth possible condition is that the change in the height of the outline 64 is less than a negative constant, and the change in the width of the outline is greater than or equal to zero.

The four conditions guarantee that a pinch and zoom gesture (which requires both height and width to be growing or shrinking together) will not be interpreted as a multi-touch area rotation gesture. There are special conditions in pinch and zoom where if the fingers are on an axis and performing the gesture, the method will enable detection of the pinch and zoom gesture even though the outline 64 is not growing in one direction.

In FIG. 7, the change of the width of the outline 64 from position 1 to position 2 is less than a negative constant, while the change in height is greater than zero. This condition only needs to be met once per gesture.

The third step of the algorithm is to make certain that at least one corner is planted in the outline 64. However, it is possible that two corners are planted if the user's finger that is making an arc (the arc finger) is moving parallel with the edge of the touchpad 60. If the finger at point P 76 had moved, then there would be no planted finger and thus the gesture would not be considered a multi-touch area rotation gesture.

Now, if two corners of an outline 64 are considered to be planted because of insufficient information to determine which one really is, the fourth step is that the tracking data should be used to “guess” which finger is actually planted. For example, if outline 72 had not increased in height, then the top y-axis value would have remained constant through the entire gesture. Thus, two edges of the outlines 70, 72 74 would have remained constant, and it would be impossible to tell which corner was actually planted, and which was the arc finger that is moving.

By observation it has been determined that in the plant and multi-touch area rotation gesture, most people will place their plant finger on the touchpad 60 first. The touchpad 60 will then continue to report this location as the planted corner even when a second finger is placed on the touchpad. It is preferable not to use this data unless absolutely necessary. This is because if the user places a moving finger on the touchpad 60 first, the method of the present invention will report that the multi-touch area rotation gesture is moving in an opposite direction.

The fifth step is to determine if the arc finger is moving (up, down, right, left). Tracking direction of movement of the arc finger is accomplished by observing how the edges of the outlines 64 change. In FIG. 7, the edge 80 is seen to move across the touchpad 60 from left to right. Thus we know the arc finger is moving to the right.

In contrast, if the arc finger moved diagonally across the touchpad 60, the axis upon which the arc finger moved the farthest is reported as the direction of movement. Only one movement direction can be reported as being the direction of movement to be tracked by the algorithm.

The sixth step is to determine the location of the arc finger in relation to the planted finger (above, below, right, left). Determining actual locations of fingers is accomplished by examining the center point of the outline 64 and seeing where in relation to the planted finger the arc finger is located. In FIG. 7, the center of the outline 64 moves from 1 (above/left) to 2 (above) to 3 (above/right). Because the center of the outlines 54 is consistently above the planted finger, the arc finger is considered to be located above the planted finger. It is also acceptable that if the arc finger is constantly to the right and above the plant finger to report both conditions as being true.

With the two pieces of information calculated in steps 5 and 6, namely the direction of movement of the arc finger and the location of the arc finger relative to the planted finger, the seventh step of the algorithm is to determine if the multi-touch area rotation gesture is a clockwise or counterclockwise rotation. There are eight valid states that can exist when dealing with rotation.

For clockwise rotation, the four possible states of the arc finger are:
a. Arc finger is above and moving to the right.
b. Arc finger is below and moving to the left.
c. Arc finger is to the right and moving down.
d. Arc finger is to the left and moving up.

For counterclockwise rotation, the four possible states of the arc finger are:
a. Arc finger is above and moving to the left.
b. Arc finger is below and moving to the right.
c. Arc finger is to the right and moving up.
d. Arc finger is to the left and moving down.

From these eight different states, all other combinations do not make sense when trying to detect a multi-touch area rotation gesture and are therefore ignored. Thus, if two arc finger locations are reported, only one of the locations will make sense with the reported arc finger movement.

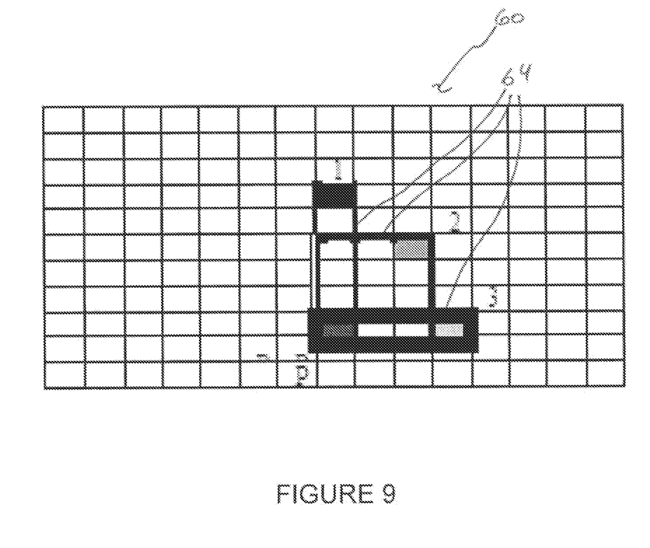

For example, in FIG. 9, the position of the arc finger on the touchpad 60 is both to the right and above of the planted finger at position “1”. The arc finger movement will be reported as down because the width of the box changes less than the height of the outline 64 as the arc finger moves to position “2” and then to position “3”. Since the combination of down and above makes no sense, only down and to the right make sense. Accordingly, rotation will be considered to be in a clockwise direction.

To help reduce unintended rotations, the ninth step of the algorithm is to increment or decrement a counter based upon if a clockwise or counterclockwise rotation is detected. If the counter reaches a certain magnitude, it sends a rotation command. Otherwise, when the multi-touch area rotation gesture is completed, the tenth step is to check and see in what direction the arc finger appears to have been going, and the rotation command is again transmitted. This check prevents a single bad sample from causing the algorithm to send a false rotation command.

The prior art methods of multiple object detection and tracking see each pointing object on the touchpad. In contrast, the multi-touch area rotation gesture is unique in that it does not require the tracking of multiple individual pointing objects on the touchpad in order to recognize the gesture.

The present invention teaches a data collection algorithm which begins at an outside edge and moves inwards or across a touchpad. Alternatively, the data collection algorithm could begin at a center and move outwards towards the outer edges of the touchpad.

The present invention has also focused on the detection and tracking of objects on a rectangular touchpad. In a circular touchpad, the circular detection area could just be an overlay over a rectangular grid. However, a circular electrode grid might also be used. In a first circular embodiment, the data collection algorithm stops when it reaches a first object as the algorithm moves from the single outer edge towards the center of the touchpad, or from the center outward in all directions toward the outer edge.

However, in a second circular embodiment, the circular electrode grid might be segmented into quadrants like pieces of a pie. Thus, the data collection algorithm would detect one object in each of the separate quadrants.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A method for tracking a multi-touch area gesture on a touch sensitive surface, said method comprising the steps of:
1) detecting at least two objects on a touchpad and defining a quadrilateral based on the at least two objects;
2) determining if a corner of the quadrilateral has a planted finger that is stationary;
3) determining if a change in height and width of the quadrilateral meets predefined criteria for being a change in movement of an arc finger;
4) determining a direction of movement of the arc finger;
5) determining a location of the arc finger relative to the planted finger; and
6) determining a direction of rotation of the arc finger and assigning the direction of rotation to be the direction of rotation of the area rotational gesture.

2. The method as defined in claim 1 wherein the method further comprises the step of determining if two corners of the quadrilateral are considered to contain a planted finger.

3. The method as defined in claim 2 wherein the method further comprises the step of assigning one of the planted fingers to be planted and the other finger to be the arc finger if the data is unclear as to which finger is planted.

4. The method as defined in claim 3 wherein the method further comprises the step of assigning the first finger that touches the touchpad to be considered the planted finger, and the second finger to touch the touchpad to be the arc finger.

5. The method as defined in claim 3 wherein the method further comprises the step of assigning the first finger that touches the touchpad to be considered the arc finger, and the second finger to touch the touchpad to be the planted finger.

6. The method as defined in claim 1 wherein the method further comprises the step of determining if a change in height and width of the quadrilateral meets predefined criteria for being a change in movement of an arc finger by comparing the change in height and width to the following four criteria:
a. the change in the width of the box is greater than a constant, and the change in the height of the box is less than or equal to zero;
b. the change in the width of the box is less that a negative constant, and the change in the height of the box is greater than or equal to zero;
c. the change in the height of the box is greater than a constant, and the change in the width of the box is greater than or equal to zero; and
d. the change in the height of the box is less than a negative constant, and the change in the width of the box is greater than or equal to zero.

7. The method as defined in claim 1 wherein the method further comprises the step of observing an edge of the quadrilateral to determine in which direction the arc finger is moving.

8. The method as defined in claim 1 wherein the method further comprises the step of assigning the direction of the arc finger to be a clockwise rotation if the arc finger is determined to having the following location and direction:
a. the arc finger is above and moving to the right;
b. the arc finger is below and moving to the left;
c. the arc finger is to the right and moving down; and
d. the arc finger is to the left and moving up.

9. The method as defined in claim 1 wherein the method further comprises the step of assigning the direction of the arc finger to be a counterclockwise rotation if the arc finger is determined to having the following location and direction:
a. the arc finger is above and moving to the left;
b. the arc finger is below and moving to the right;
c. the arc finger is to the right and moving up; and
d. the arc finger is to the left and moving down.

10. The method as defined in claim 1 wherein the method further comprises the step of assigning a counter to a rotation command, wherein the counter is incremented each time that a clockwise rotation is detected and decremented each time that a counterclockwise rotation is detected.

11. The method as defined in claim 10 wherein the method further comprises the step of performing a clockwise rotation if the counter reaches a predetermined magnitude, and performing a counterclockwise rotation of the counter reaches a predetermined magnitude.
